(19) United States
(12) Patent Application Publication
(10) Pub. No.: US 2008/0276270 A1
(43) Pub. Date: Nov. 6, 2008

(54) SYSTEM, METHOD, AND APPARATUS FOR IMPLEMENTING TARGETED ADVERTISING IN COMMUNICATION NETWORKS

(76) Inventors: Chandra Shekar Kotaru, California, CA (US); Prakasa Rao Ragala, Visakhapatnam (IN); Paratieshwara Rao, Kharagpur (IN); Divya Murthy Komati, China Vellamilli (IN)

Correspondence Address: Gaian Consulting Services Inc, 1126 Vincent St., Redondo Beach, CA, 90277, US

(21) Appl. No.: 12/168,212

(22) Filed: Jul. 7, 2008

(30) Foreign Application Priority Data
Jun. 16, 2008 (IN) 1448/CHE/2008

(51) Int. Cl. H04N 7/025

(52) U.S. Cl. 725/34

(57) ABSTRACT

The present technique detects at least one active user utilizing a set of communication devices over a communication network. The method includes receiving behavior data, fulfillment data and feedback data for the at least one active user of the set of communication devices accessing content over the communication network using an intelligent agent module. The method includes creating a database of a set of demographic profiles based on the received data using a dynamic group and rules editor module. The method further includes grouping a set of the at least one active user of the set of communication devices into their corresponding dynamic group using group creation service module.

### TECHNICAL FIELD OF THE INVENTION

The present technique relates generally to techniques for producing targeted advertising. In one aspect, the technique implements targeted advertising in communication networks.

### BACKGROUND OF THE INVENTION

In various applications, advertising enterprises utilize several different communication mediums for distributing advertising such as television, radio, internet, billboards or the like.

Television advertising has been a popular means for communicating advertisements for several years. In effectiveness, an advertisement needs to be viewed by the targeted audience. There are various measures taken to increase the chances a desired target audience will see the advertisement.

In many applications, however, advertising enterprises will determine a desired target audience based upon a particular type of programming. By a way of example, an advertisement directed to an MP3 player may be presented during a program that features music such as concert, music awards show or the like. In addition, programming content created for a particular age range such as cartoons for children under fourteen or the like may be used to determine advertising placement. There are many variables that may influence the target audience viewing choices such that an advertiser may not fully be able to quantify or appreciate the actual success or failure of a particular advertisement such as digital video recording devices that skip commercials which may result in lower saturation of the advertisement in the target audience. In relevant, in the said group creation most of the variables depend on static demographic variables or dynamic variables only. In contrary, when demographic information or when people of various demographic groups are at the same place these groups creation may not be enough to serve desired results.

Conventional techniques calculate advertisement success rate based on statistical data derived on basis of number of times the advertisement is displayed. In addition, calculations may lead to errors as purchases are made by the user.

Accordingly, there is a need to provide more accurate targeted advertising, either the success or failure, whereby tracked by relevant parties.

### SUMMARY OF THE INVENTION

The present technique detects at least one active user utilizing a set of communication devices over a communication network. The method includes receiving behavior data, fulfillment data and feedback data for the at least one active user of the set of communication devices accessing content over the communication network using an intelligent agent module. The method includes creating a database of a set of demographic profiles based on the received data using a dynamic group and rules editor module. The method further includes grouping a set of the at least one active user of the set of communication devices into their corresponding dynamic group using group creation service module. The method receives a request from the set of the at least one active user to present a targeted advertisement to the at least one active user of the set of communication devices using a business parameters module. The method further identifies one of the set of demographic profile in the created database that satisfies criteria set forth in the business parameters module. In addition, the method transmits the targeted advertisement to the set of communication devices associated with the demographic profile satisfying the criteria set forth in the business parameters module.

In one embodiment, the present technique includes detecting personality of at least one active user of a set of communication device over a communication network. The method includes identifying current personality of the at least one active user watching the set of the communication devices over the communication network. The method further includes detecting present viewing personality by comparing current user behavior data with predefined default user behavior data for the at least one active user of the set of the communication devices over the communication network using an inference engine module. Additionally, the method includes detecting the at least one active user of the communication device by polled metric data using an intelligent agent module.

In another embodiment, the present technique includes detecting at least one best fit product to deliver a targeted advertisement to a set of communication devices over a communication network. The method includes producing optimal revenue from the targeted advertisement using autonomous closed loop feedback module. Furthermore, the method includes managing an advertisement campaign by selling one of the at least one best fit product using autonomous campaign management module.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is depicts an illustrative embodiment of an internet protocol television (IPTV) system delivering targeted advertising to an end user client device;

FIG. 2 depicts a flowchart of functions performed in an illustrative embodiment;

FIG. 3 depicts a flowchart illustrating a design process indicative for detecting an active user in an illustrative embodiment;

FIG. 4 depicts an illustrative embodiment of an IPTV system for providing targeted advertisings being delivered to a determined active user at a specific time frame;

FIGS. 5 & 6 depict data structures provided in an illustrative embodiment.

FIG. 7 illustrates exemplary system for supporting a place in accordance with another embodiment of the present invention;

FIG. 8 illustrates exemplary data for supporting a place in accordance with another embodiment of the present invention;

FIG. 9 is a schematic diagram depicting a communication network employing multiple IPTV instances in accordance with another embodiment of the present invention;

FIG. 10 is a functional block diagram depicting an exemplary system for producing optimal revenue from advertising with another embodiment of the present invention;

FIG. 11 is a functional block diagram depicting an exemplary system for prioritizing to schedule a targeted advertising with another embodiment of the present invention;

FIG. 12 is a functional block diagram depicting an exemplary system for creating groups with another embodiment of the present invention; and

FIG. 13 is a functional block diagram depicting an exemplary system for detecting an active user associated with personality detection with yet another embodiment of the present invention.

### DETAILED DESCRIPTION OF THE INVENTION

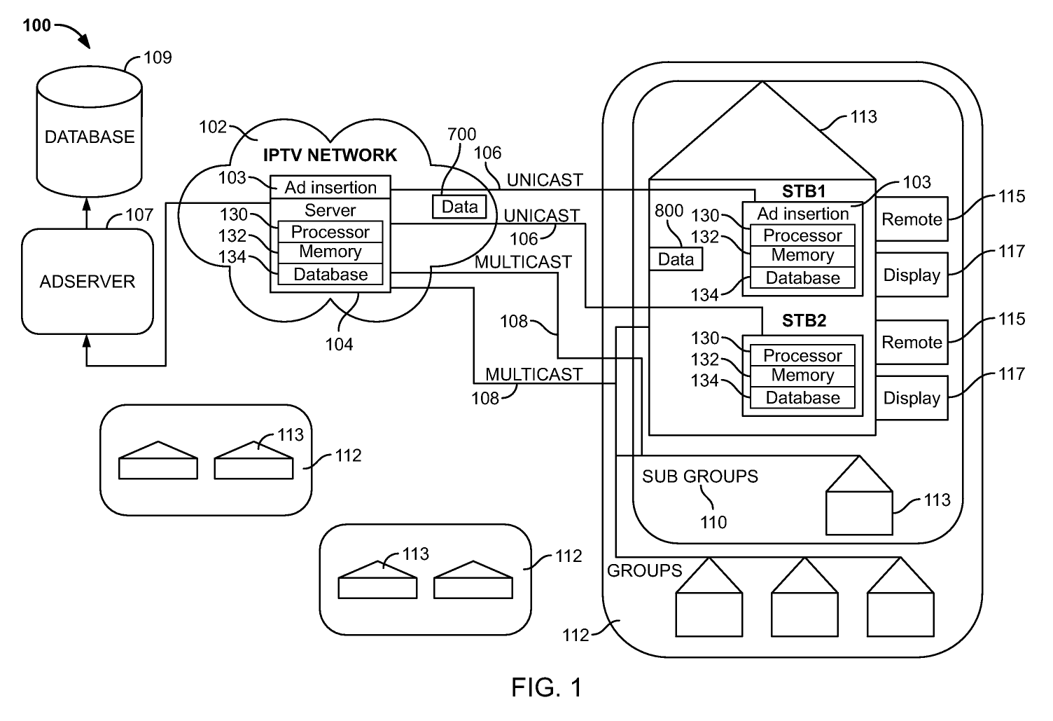

Referring to FIG. 1 in an IPTV network 102 content and advertisements to the server 104 are delivered. The server 104 delivers content and advertising via unicast or multicast on the target group of end user client devices to which the advertising is directed. As shown in FIG. 1 groups 402 receive multicast 108 advertising from the server 104. Subgroups 110 receive multicast 108 advertising from the server 104. Individual households receive unicast 106 advertising to set top box (STB) 111. More than one set top box can be located in an individual household 113 and each individual STB 111 tailored to target the user watching television at that particular STB 111. Each server 104 and STB 111 has an associated remote control 115 and display 117.

FIG. 1 depicts an illustrative advertising insertion system wherein advertising can be inserted at the IPTV server or at the end user client device, for example, an STB. Advertising data can be inserted into an IPTV video stream via advertising insertion device 103 at the IPTV server 104 or the STB 111. The IPTV server includes an advertising server 107 and an advertising database 109. The advertising data is selected from the advertising database and delivered by the advertising server 107 to the IPTV server 104.

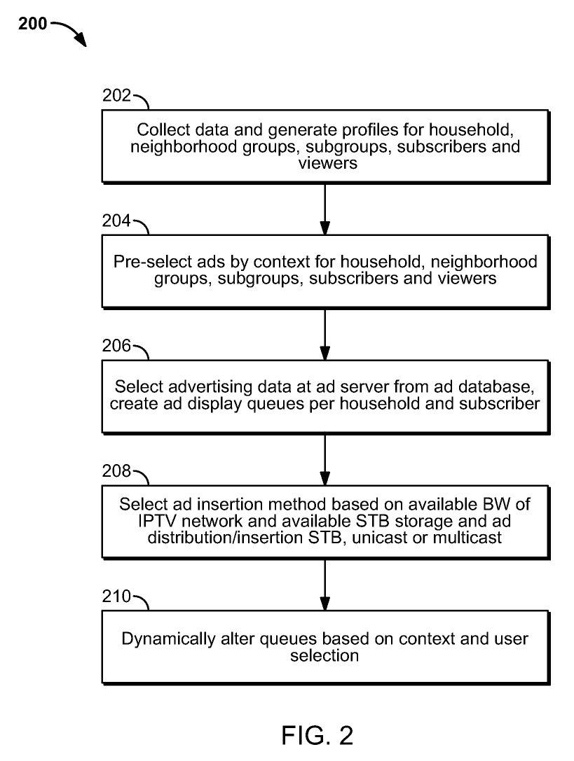

Referring to FIG. 2, in an illustrative embodiment a set of functions are performed as shown in flowchart 200. At block 202 an illustrative embodiment IPTV system collects data and generates demographic profiles for users, viewers, households and neighborhoods. The neighborhoods represent groups or sub-groups of households containing one or more end user client devices (STBs) associated with one or more IPTV users or viewers. Each household may have one or more client devices or STBs which receive IPTV video streams and inserted advertising or advertising data to be inserted into the WPTV video stream. At block 204 advertisements are pre-selected for distribution to users, households, sub-groups and groups of end user client devices. The sub-groups can be smaller than the groups and can represent partial selection of a particular group. The advertisings are selected by context for the users, household of end user client devices, and groups. Context includes but is not limited to available IPTV bandwidth between the IPTV server and the end user client device available bandwidth at the end user client device, the demographics and interests for the users or viewers, households and groups as well as the geographical location of the users, households, and groups or sub-groups as correlated with the advertisement target segment of users or viewers chosen by an advertiser.

Advertisement target segment includes the demographics and interests of the users as well as their geographic location. Context may also include what IPTV video stream is currently being displayed or viewed at a particular set top box by a viewer or user. The terms viewer and user are used interchangeably herein. At block 206 the illustrative embodiment creates advertising queues for each household, viewer and group or sub-group. For each household, viewer and group or sub-group display queue, advertising data is generated for on screen advertisings. The group display queue indicates which advertisings are displayed as on screen picture-in-picture displays (PIPs), which are off screen scrollable PIPs and which advertising is the main advertising. The second group advertising data are pre-selected advertisings that are off screen PIP advertisings that can be scrolled onto the screen as on screen PIP advertisings.

The illustrative embodiment also generates a follow-on queue and follow-on advertisements (FOA) which are related to the on screen advertisings which are queued to be presented to the viewer upon selection of one of the advertisings in the on screen queue which are to be displayed upon selection of an on screen advertising. An on screen advertising can be selected for main screen display or for FOA. Thus when a viewer selects an on screen advertising using a remote control by placing a cursor over the on screen advertising on the display device, the on screen advertising previously displayed as PIP advertising becomes the main display and the FOA advertisings related to the selected on screen PIP advertising (which is now the main screen advertising) are moved to the on screen queue and displayed as on screen PIP advertising. In block 208 the illustrative embodiment selects an advertising delivery method based on available IPTV network bandwidth. The illustrative embodiment also selects an advertising distribution insertion method based upon available IPTV bandwidth and storage at an end user client device (i.e. STB), that is, whether or not the advertising and the queues will be inserted at the IPTV server and delivered in unicast or multicast or whether the advertising and queues will be delivered to the set top box for insertion at STB during viewing by the user.

At block 210 the illustrative embodiment dynamically alters the queues and the advertising data based on the context and the user selection. The inserted advertising data and display queues vary depending on the profile for a group, sub-group, household or viewer targeted. A group of advertisings data can be multicast to group members and different unique group displays queue and sees unique main screen advertising and on screen PIPs displayed. Thus a group of advertisings may contain advertisings targeted to different sub-groups and each sub-group receives a different display queue indicating a different set of advertisings from the multicast advertisings in the group advertising data. The display queue data is much smaller than the advertising data and thus requires less bandwidth to transmit queue data when compared to transmitting advertising data.

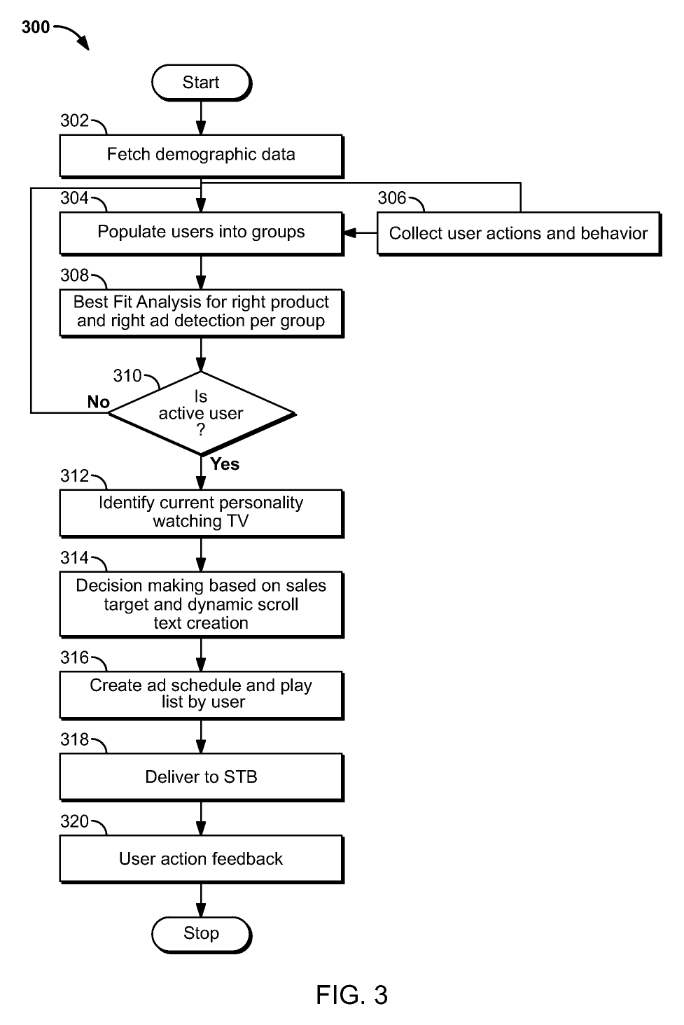

Referring to FIG. 3, is a flowchart illustrating a design process indicative to provide targeted advertising, in accordance with an aspect of the present technique.

At step 302 an illustrative embodiment fetches demographic data. The embodiment also receives behavior data, fulfillment data and feedback data for the at least one active user of the set of communication devices accessing content over the communication network using an intelligent agent module. The demographic and user action profiles are gathered. The demographic data profiles and the user actions data profiles are gathered from the active user interacting with the communication devices. The user profiles are disseminated with a digital program insertion or commercial insertion point as broadcasting via the targeted advertisements through respective channels. The targeted advertising includes a set of at least one of a banner advertisement or a video advertisement or a scrolling advertisement or a combination thereof.

At step 304 an illustrative embodiment populates the user into their respective groups. The database creates a set of demographic profiles based on the received data using a dynamic group and rules editor module. The grouping includes the active user of the communication devices populated into their corresponding dynamic group using group creation service module. The content over a network are accessed. The demographic data profiles and the user actions data profiles content are accessed over a network using a group creation service module. The group creation service module places periodically the user actions data profiles into corresponding groups. An intelligent neural network based inference engine module detects and distinguishes one or more family member operating a STB group module. The inference engine tags a plurality of pieces of content with Meta data allowing showing the targeted advertising.

At step 306 the illustrative embodiment collects all user actions and user behavior. The active user of the set of communication devices into their corresponding dynamic group using group creation service module the demographic and user action profile using a database is created. An ad agent is used to dynamically receive the targeted advertising and compose an original advertisement from the machine readable format. An autonomous closed loop feedback module is used to produce optimal revenue from the targeted advertising or a plurality of selling products or a set of services or a combination thereof. The autonomous closed loop feedback module is used to manage the targeted advertising campaigns.

At step 308 the illustrative embodiment analyzes a best fit for a right advertisement of the group or sub-groups using the product. The user activities with the data profiles are identified. The user activities includes a user watching television programs or channels or a set of user actions data profiles which includes one weekday and one weekend day or a set of user actions data profiles that includes switching alternatively from the channels. The user is detected, wherein the user interacts with the targeted television programs being displayed to an empty room or to an audience. The audience is not interacting with the plurality of targeted television programs.

At step 310 the illustrative embodiment identifies whether the user is an active user. The target advertising to communication devices is transmitted. The targeted advertising to one or more communication devices is transmitted. While broadcasting the plurality of targeted channels as at least one DPI trigger arrives includes information for indicating the STB group module to subscribe a plurality of multicast streams. An authoring language module and a rules grammar module for defining a set of rules by enabling the inference engine is used to compute a plurality of custom offers at a plurality of custom prices.

At step 312 the illustrative embodiment identifies current personality watching the communication devices. The user activities are verified as to whether the demographic data profiles and user actions data profiles satisfy one or more business parameters. The set of advertisements are dynamically authored and customized in a machine readable format by the inference engine to target the user watching a plurality of targeted television programs. The authoring language module and the rule grammar module are used to define the set of rules for enabling a set of one of a service operator or a content owner or a product merchant or a combination thereof.

At step 314 the illustrative embodiment based on sales target and dynamically create scroll text. Further, the illustrative embodiment identifies one of the set of demographic profile in the created database that satisfies criteria set forth in the business parameters module. The illustrative embodiment receives behavior data, fulfillment data and feedback data for the at least one active user of the set of communication devices accessing content over the communication network using an intelligent agent module. The illustrative embodiment creates a database of a set of demographic profiles based on the received data using a dynamic group and rules editor module. The method includes grouping a set of the at least, one active user of the set of communication devices into their corresponding dynamic group using group creation service module.

At step 316 the illustrative embodiment creates ad schedule and user play lists. The illustrative embodiment tags an accessed content over the communication network for producing the delivery of the targeted advertisement into a plurality of pieces associated with Meta data. The method detects digital program insertion or splice point in a main stream of a channel and replacing a dynamic targeted advertisement using a plurality of secondary streams and returning back to the main stream at end of the splice point. The method receives the targeted advertisement and composes a real advertisement. The module 420 generates a dynamic banner and a scrolling advertisement using a dynamic up selling text module. The method further provides product information and fulfillment to one of the specific targeted advertising.

At step 318 the illustrative embodiment delivers to the STB by transmitting the targeted advertisement to the communication devices associated with the demographic profile satisfying the criteria set forth in die business parameters module At step 320 the illustrative embodiment receives the user actions feedback. The ads composer module is used to dynamically create the set of advertisements for at least one new product or at least one existing product in a custom fashion for each of the user of the STB module. The illustrative embodiment receives a request from the set of the at least one active user to present a targeted advertisement to the at least one active user of the set of communication devices using a business parameters module.

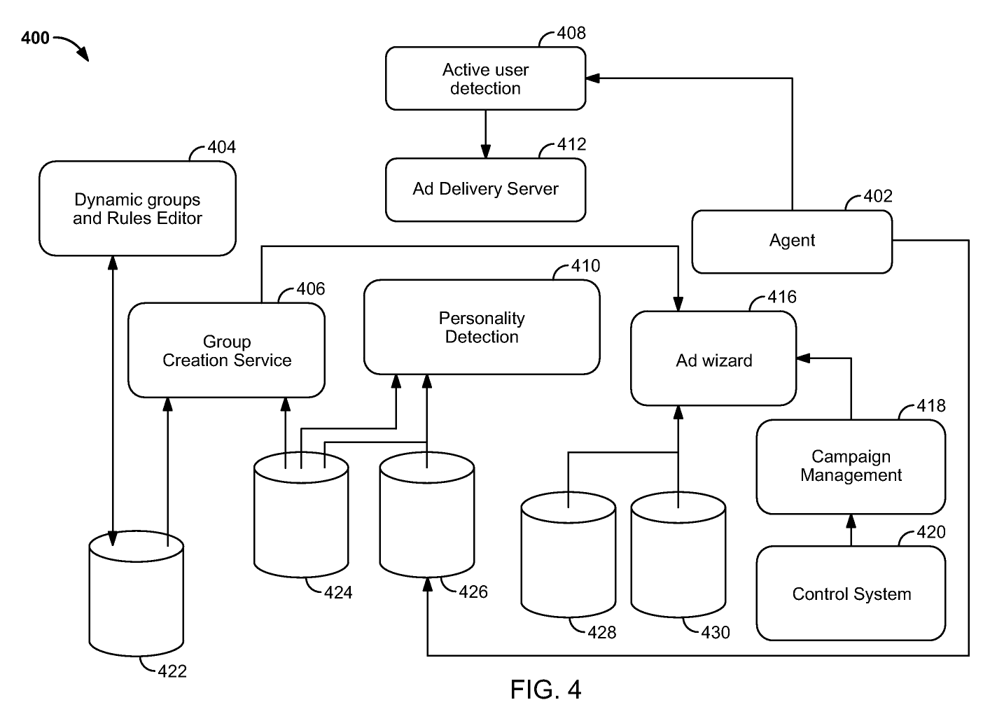

Referring to FIG. 4 depicts an illustrative embodiment 400 of an IPTV system 100 for providing targeted advertisings being delivered to a determined active user at a specific time frame. The system 100 delivers a digital television service to one or more users using internet protocol over a broadband connection. The system 100 uses two-way communication and uses broadband technology using the one or more communication devices.

In one aspect, the illustrative embodiment 400 includes an agent 402, a dynamic group and rules editor (DGRE) module 404, and a group creation service (GCS) module 406, an active user detection module 408, personality detection module 410, a server 412, ad wizard module 416, a campaign management module 418, a control system 420, a group database (GDB) 422, a user database (SDB) 424, user actions database (UDB) 426, a product database (PDB) 428 and an ads database (ADB) 430. The agent 402 is an intelligent system which observes the user actions and catches the raw information and sends it to the UDB 426. The agent 402 receives behavior data, fulfillment data and feedback data for one or more active user of the set of communication devices accessing content over the communication network. The agent 402 detects the active user of the communication device by polled metric data.

The DGRE module 404 creates a group database 422 of a set of demographic profiles based on the received data. The module 402 computes custom offers at custom prices to define the set of rules for enabling an authoring language and a rules grammar to service operators or content owners or product merchants or combination thereof. The module 402 delivers the targeted advertisement in a machine readable format by authoring and customizing. The module 402 authors one or more languages for defining a set of rules to compute custom offers at custom prices. The module 402 enables one or more services to multiple clients including a service operator or an owner or a product merchant or the like thereof.

The GCS module 406 is the core component to create new groups based on one or more user actions. The module 406 mines the raw data from the GDB 422 and prepares the user actions. The module 406 also calculates the users in the groups periodically. The illustrative embodiment further informs the server 412 as which user belong to which group. The module 406 groups the active user of the communication devices into their corresponding dynamic group. The database 426 receives a request from the active user to present a targeted advertisement to the active user of the communication devices. The database 424 identifies a set of demographic profiles in the created database 422 that satisfies criteria set forth in the module 406.

The server 412 transmits the targeted advertisement to the associated demographic profile satisfying the criteria set forth in the module 406. The targeted advertisement for the active user of the communication devices over the communication network that is using either context specific or time specific or demographic profile specific or the like or a combination thereof is delivered via the server 412. The targeted advertisement via a set of content delivery mechanisms including live television or video on demand or video advertisements or the like or the combination thereof is also delivered via the server 412. In addition, the targeted advertisement via the control system 420 comprises launching the targeted advertisement through either banner advertisements or video advertisements or scrolling advertisements or the like or the combination thereof.

In another aspect, the illustrative embodiment includes the campaign management module 418 categorizing the active user into the dynamic group based on the user actions and the set of demographic profiles. The ad wizard module 416 includes the set of demographic profile includes user-selected preferences with respect to programming content sources. The database 422 comprises the behavior data including a prior collection of activities conducted via the set of communication devices such as program content viewed, a time frame that the program content was viewed, an amount of time the at least one active user spent viewing the program content and purchasing activities conducted via the set of communication devices.

The module 416 includes the time frame for presenting the advertisement that is determined by prioritizing and scheduling the advertisement for the active user based on an average viewing time and advertisement opportunity using current success potentials of one of the targeted advertisement. The database 426 includes the external data such as income range of the active user of the set of communication devices, family structure including martial status and number of dependents, residential location of the at least one active user, gender of the at least one active user, age range of the at least one active user and credit worthiness of the at least one active user. The ads database 430 comprises number of times the targeted advertisement is presented, a time frame for presenting the targeted advertisement, a program during which the targeted advertisement is presented, a target audience to which the targeted advertisement is presented and a geographic area in which the targeted advertisement is presented.

The ad wizard 416 determines whether the active user of the set of communication devices to which the targeted advertisement was transmitted have perceived the targeted advertisement by sampling a content data stream distributed to the set of communication devices of the active user during presentation of the targeted advertisement of the active user. The module 418 mapping the targeted advertisement to the dynamic group defined groups using seed success and the current success potentials. The module 410 detects personality of the at least one active user of the set of communication device over the communication network. The module 410 identifies current personality of the active user watching the set of the communication devices over the communication network. Additionally, the module 410 detects present viewing personality by comparing current user behavior data with predefined default user behavior data for the at least one active user of the set of the communication devices over the communication network.

In another aspect, the illustrative embodiment includes the module 416 tags an accessed content over the communication network for producing the delivery of the targeted advertisement into a plurality of pieces associated with Meta data. The module 418 detects digital program insertion or splice point in a main stream of a channel and replacing a dynamic targeted advertisement using a plurality of secondary streams and returning back to the main stream at end of the splice point. The module 420 receives the targeted advertisement and composes a real advertisement. The module 420 generates a dynamic banner and a scrolling advertisement using a dynamic up selling text module. The module 420 further provides product information and fulfillment to one of the specific targeted advertising.

The module 420 provides bookmark on the targeted advertisement, for lateral fulfillment without obstructing the current program of the communication device over the communication network. The targeted advertisement to the active user is based on a behavior data or a fulfillment data or a feedback data or the like or the combination thereof. The module 416 detects at least one best fit product to deliver the targeted advertisement to the set of communication devices over the communication, network using the database 428. The module 416 also produces optimal revenue from the targeted advertisement using autonomous closed loop feedback module using the database 430. The module 418 manages an advertisement campaign by selling one of the at least one best fit product. The brick module 418 further conceptualizes and identifies design of the autonomous campaign management module. The module 420 specifies automatically a set of goals for producing optimal revenue from the targeted advertisement.

In yet another aspect, the illustrative module includes the scripting module 404 makes a set of scrolling advertisements of the targeted advertising using a plurality of scripting constructs and key variables of a scripting module. The module 408 identifies the best fit product to the at least one active user and at least one user group. The module 408 identifies the best fit product includes identifying a best fit targeted advertisement to the best fit product of the at least one user group. The module 410 computes the time frame for delivering the best fit targeted advertisement to the at least one user group.

The module 410 propagates switching to the targeted advertisement on a live television channel during a specific commercial break. The module 408 creates the targeted advertisement based on a plurality of user preferences and a plurality of user reactions. The module 408 detects the at least one active user is interacting with one of the set of communication devices. The module 408 detects the at least one active user is interacting with one of the set of communication devices. The module 408 firstly, if the live television channel is being displayed to the at least one active user either paying attention or watching the live television channel else secondly if the live television channel is being displayed to an empty room or to at least one passive user not paying attention or watching the live television channel.

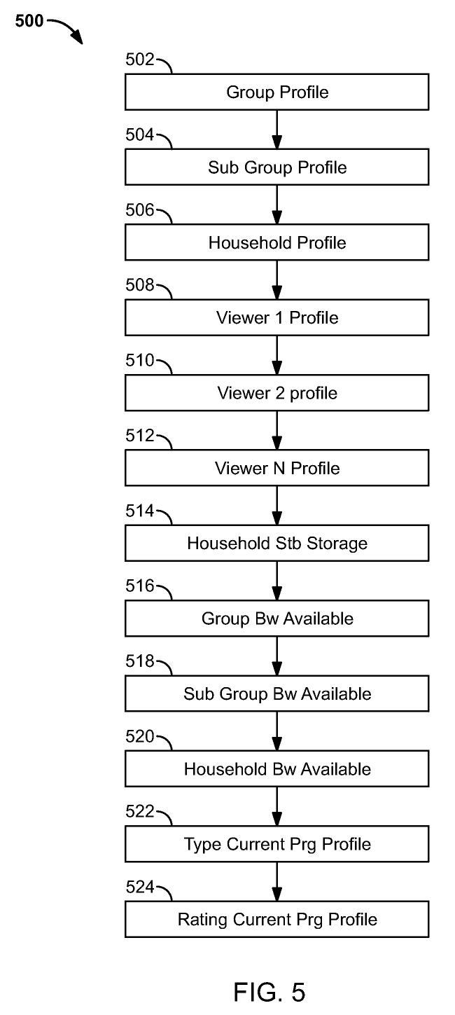

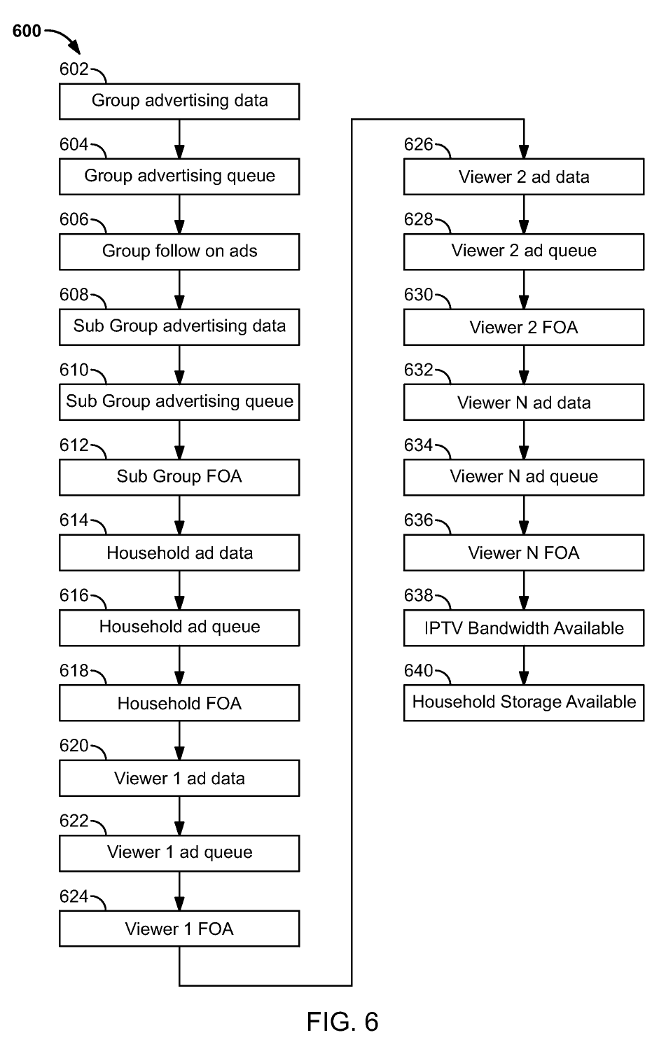

Referring to FIG. 5, in an illustrative embodiment a data structure is provided embedded in memory wherein data is stored representing values for operation as disclosed herein. As shown in FIG. 5 at 502 a group profile data field is provided for containing data indicating a profile for a group. As shown in 504 a sub-group profile filed is shown for containing data indicative of a profile for a sub-group. At 506 a household profile field is shown for storing data indicative of a profile for a household. At 508 a viewer 1 profile field is shown for storing data indicative of a profile for a first viewer or viewer 1 within a household. At 510 a viewer 2 profile field is shown for containing data indicative of a profile for a second viewer within the same household. At 514 a household STB storage field is shown for indicating the available storage within a particular set top box at a household.

There may be more than STB storage data field associated with one or more STB storage devices within a particular household. In a particular embodiment advertising data can be sent to an STB for insertion at the STB when the STB has sufficient storage to hold the advertising data recording. Thus, if a predetermined amount of storage (for example, one gigabyte) is available the advertising data can be sent to the STB for storage. At 516 a group bandwidth available field is illustrated for holding data indicative of a bandwidth available between an IPTV server and a group of selected set top boxes for targeting advertising data delivery.

In another particular embodiment if the IPTV available bandwidth exceeds a predetermined value, for example, the advertising data can be inserted at the IPTV server. At block 518, a sub-group bandwidth available field between an IPTV server and a sub-group of client devices or set top boxes within the selected sub-groups. At 520 a household bandwidth available field is shown for holding data indicative of an available bandwidth between an IPTV server and a household containing one or more STBs or end user client devices.

At 522 a type current program viewed field is shown for containing data indicative of the type of program that is currently being viewed by a particular viewer at a particular set top box. The type current program may indicate whether or not the program type is sports, news, entertainment, travel, or some other category as well as a rating for the program being viewed. At 524 a rating current program viewed field is shown for storing the rating of the current program being viewed at a particular set top box by a particular viewer. If the rating is a movie it may be rated by the Motion Picture Association of America (MPAA) rating standards including NC17, R, PG, PG13, and G. Thus follow-on advertisings can be selected that match a MPAA rating for a program or for a viewer who allows or sets an MPAA rating for FOA advertisings.

Referring to FIG. 6, a data structure 600 is provided for storing data in an illustrative embodiment. At 602 a group advertising data field is illustrated for storing advertising data for a particular group. At 604 a group advertising queue data field is shown for storing indicative of a queue for the advertising data in the group advertising data. At 606 a group follow-on advertisings data field is provided for holding follow-on advertisings data and follow-on display queue data related to the group advertising data. At 608 a sub-group advertising data field is provided for storing data comprising advertising data targeted to a particular sub-group. At 610 a sub-group advertising queue field is provided for storing a sub-group advertising display queue for advertising data directed to a particular sub-group. At 610 a sub-group follow-on advertising queue related to the advertising data directed to the particular sub-group. At 614 a household advertising data field is illustrated for containing data indicative of household advertising data and a household display queue targeted to a particular household. At 616 a household advertising queue data field is illustrated for holding indicative a household advertising queue for arranging display of the household advertising data. At 618 a household follow-on advertising data field is illustrated for containing follow-on advertisings and a follow-on display queue related to the household advertising data. At 620 a viewer 1 advertising data field is provided for containing data targeted to a particular first viewer. At step 622 a viewer display queue field is provided for storing an advertising data queue data for the first viewer. At 624 a viewer 1 follow-on advertisings data field is illustrated for storing follow-on advertisings data field is illustrated for storing follow-on advertisings data and a display queue related to the viewer 1 advertising data. Advertising data, queue data and a follow-on advertisings data for viewers 2-N are stored in the data structure in fields 626-636. At 638 an IPTV bandwidth is available field is shown for storing data indicative of IPTV bandwidth available between an IPTV server and a group, sub-group, household, or end user client device associated with a particular viewer or user. At 640 a household storage available field is shown for containing data indicative of the amount of storage available at a particular end user client device (e.g. STB) associated with a household or a particular user or viewer.

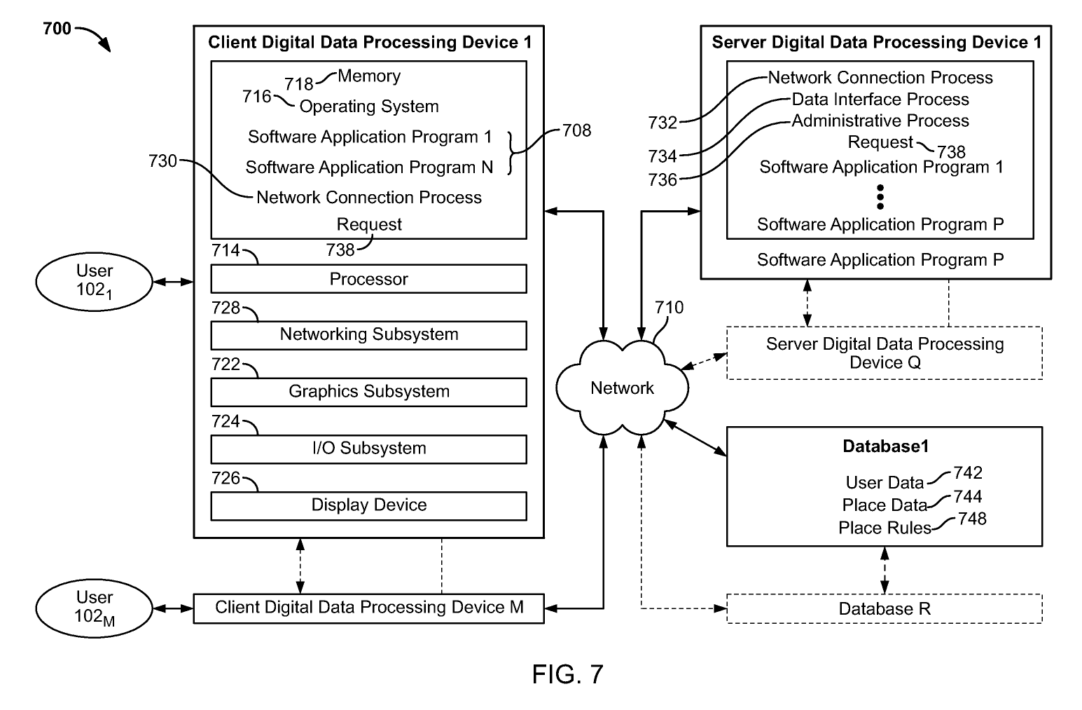

Referring to FIG. 7, a user 702₁ desiring to access a place can execute one or more software application programs 704 residing on the client 740 to generate data messages that are routed to, and/or receive data messages generated by, one or more software application programs 708 residing on server 740 via a network 710. A data message includes one or more data packets, and the data packets can include control information and payload data.

The software application programs 704 can include one or more software processes executing within one or more memories 718 of the client 720. Similarly, the software application programs 708 can include one or more software processes executing within one or more memories of the server 740.

The software application programs 708 can include one or more sets of instructions and/or other features that enable the server 740 to, for example, establish a place, regulate access to that place, and mediate interactions between the user 102₁ user 102_{M} while logged into the place via the clients 720(1) and 720(M). As described herein, the software application programs 704 and 708 can include instructions for authenticating users 702, authorizing users 702, and otherwise processing places (e.g. establishing places and administering interactions between users 702 logged into the place). The software application programs 704 and 708 can be provided using a combination of built-in features of one or more commercially available software application programs 704 and 708 are described herein as being executed in a distributed fashion (e.g. operations performed on a networked client and server 720 and 740), those of ordinary skill in the art will understand that at least some of the operations of the software application programs 704 and 708 can be executed within one or more digital data processing devices that be connected by a desired digital path (e.g. point-to-point, networked, data bus, etc).

The digital data processing device 720 and 740 can include a personal computer (PC), a computer workstation, a laptop computer, a server computer, a mainframe computer, a hand held device, an information appliance, and/or another type of generic or special-purpose, processor-controlled device capable of receiving, processing, and/or transmitting digital data. Processor 714 refers to the logic circuitry that responds to and processes instructions that drive digital data processing devices such as, without limitation, a central processing unit, an arithmetic logic unit, an application specific integrated circuit, a task engine, and/or combinations, arrangements, or multiples thereof.

Instructions for programs 704 or other executables can be pre-loaded into a programmable memory that is accessible to a processor 714 and/or can be dynamically loaded into/from one or more volatile and/or non-volatile memory elements communicatively coupled to the processor 714. The instructions can, for example, correspond to the initialization of hardware within the digital processing devices 720 and 740, an operating system 716 that enables the hardware elements to communicate under software control and enables other computer programs to communicate, and/or software application programs 704 and 708 that are designed to perform operations for other computer programs, such as operations relation to establishing and administering a place. The operating system 716 can support single-threading and/or multi-threading, where a thread refers to an independent stream of execution running in a multi-tasking environment. A single-threaded system is capable of executing one thread a time, while a multi-threaded system is capable of supporting multiple concurrently executing threads and can perform mufti tasks simultaneously.

Local user 702 can interact with client 720 by, for example, viewing a command line, using a graphical and/or other user interface, and entering commands via an input module or device, such as a mouse, a keyboard, a touch sensitive screen, a stylus, a track ball, a keypad, etc. The user interface can be generated by a graphics subsystem 722 of the client 720, which renders the interface into an on-or-off screen surface (e.g. on display device 726 and/or in a video memory). Inputs from the user 702 can be received via an input/output subsystem 724 and routed to processor 714 via an internal bus (e.g. system bus), for execution under the control of the operating system 716.

Similarly, a remote user can interact with the digital data processing devices 720 and 740 over the network 710. The inputs from the remote user can be received and processed in whole or in part by a remote digital data processing device collocated with the remote user. Alternatively and/or in combination, the inputs can be transmitted back to and processed by the local client 720 or to another digital data processing device via one or more networks using, for example, thin client technology. The user interface of the local client 720 can also be reproduced, in whole or in part, at the remote digital data processing device collocated with the remote user by transmitting graphics information to the remote device and instructing the graphics subsystem of the remote device to render and display at least part of the interface to the remote user. Network communications between two or more digital data processing devices can include a networking subsystem 728 (e.g. a network interface card) to establish the communications link between the devices. The communication link that interconnects the digital data processing devices can include elements of a data communications network, a point to point connection, a bus, and/or another type of data path.

In one operation, the processor 714 of the client 720 executes instructions associated with software application programs 704 that instruct the processor 714 to at least partially control the operation of the graphic subsystem 722 in rendering and displaying a graphical user interface on the display device 726.

The network 710 can include a series of network nodes that can be interconnected by network devices and wired and/or wireless communication lines that enable the network nodes to communicate. The transfer of data (e.g. messages) between network nodes can be facilitated by network devices such as routers, switches, multiplexers, bridges, gateways, etc that can manipulate and/or route from an originating node to a server node regardless of dissimilarities in the network topology (e.g. bus, star, token, ring) spatial distance (e.g. local, metropolitan, wide area network), transmission technology (e.g. TCP/IP, system network architecture), data type (e.g. data voice, video, multimedia), nature of connection (e.g. optical fiber, coaxial cable, twisted pair, wireless, etc) between the originating and server network nodes.

FIG. 7 shows processes 730, 732, 734 and 736. A process refers to the execution of instructions that interact while operating parameters, message data/parameters, network connection parameters/data, variables, constants, software libraries, and/or other elements within an execution environment in a memory of a digital data processing device that causes a processor to control the operations of the digital data processing device in accordance with the desired features and/or operations of an operating system, a software application program, and/or another type of generic or specific-purpose application program (or subparts thereof). For example, network connection process 730 and 732 refers to a set of instructions and/or other elements that enable the digital data processing devices 720 and 740 to establish a connection link and communicate with the other digital data processing devices during one or more sessions. A session refers to a series of transactions communicated between two network nodes during the span of a single network communication, where the session begins when the network connection is established and terminates when the connection is ended. Database interface process 734 refers to a set of instructions and other elements that enable the server 720 to access the database 750 and/or other types of data repositories to obtain access to, for example, user data 742, place data 744, and place rules 748. The accessed information can be provided to the software application program 708 for further processing and manipulation. Administrative process 736 refers to a set of instructions and other features that enable the server 720 to monitor, control, and/or otherwise administer a place. For example, the administrative process 736 can (i) maintain and update configuration, runtime, and/or session data for the one or more digital data processing devices 720,740 and/or the software application programs 704 or 708 executing on the devices 720, 740, (ii) provide buffer management, multi-threaded services and/or data structure management, (iii) provide initialization parameters to the digital data processing devices 720, 740 and/or the software application programs 704, 708, (iv) manage of groups of objects (e.g. groups of data elements stored on the digital data processing devices 720, 740, and/or stored or otherwise maintained in the database 750, groups of users authorized to access the software application programs 704 or 708, groups of licenses, etc), (v) manage relationships between objects in response to messages communicated between digital data processing devices 720, 740, (vi) provide support services (e.g. encryption and/or decryption, compression, path routing, message parsing, message format manipulation, etc) to the digital data processing devices 720, 740, and/or (vii) provide load balancing based on, for example, processor/usage availability, network usage/availability, message usage/availability, message length and/or message volume.

Although the illustrated processes 730, 732, 734 and 736 and their features are described as being separate, the illustrated processes and/or their features can be combined into one or more processes if desired. One or more of the illustrated processes 730, 732, 734 and 736 can be provided using a combination of built-in features of one or more commercially available software application programs and/or in combination with one or more custom designed software modules.

The databases 750 can be stored on a non-volatile storage medium or a device known to those of ordinary skill in the art (e.g. compact disk (CD), digital video disk (DVD), magnetic disk, internal hard drive, external hard drive, random access memory (RAM), redundant array of independent disks (RAID), or removable memory device). As shown, in FIG. 7, the databases 750 can be located remotely form the client 720 and the server 740. In some embodiments, the databases 750 can be located locally to the client 720 or sever 740 and/or can be integrated to the client 720 or server 740, respectively. The databases 750 can include different types of data content and/or different formats for stored data content. For example, the databases 750 can include tables, images, graphs and/or other types of data structures.

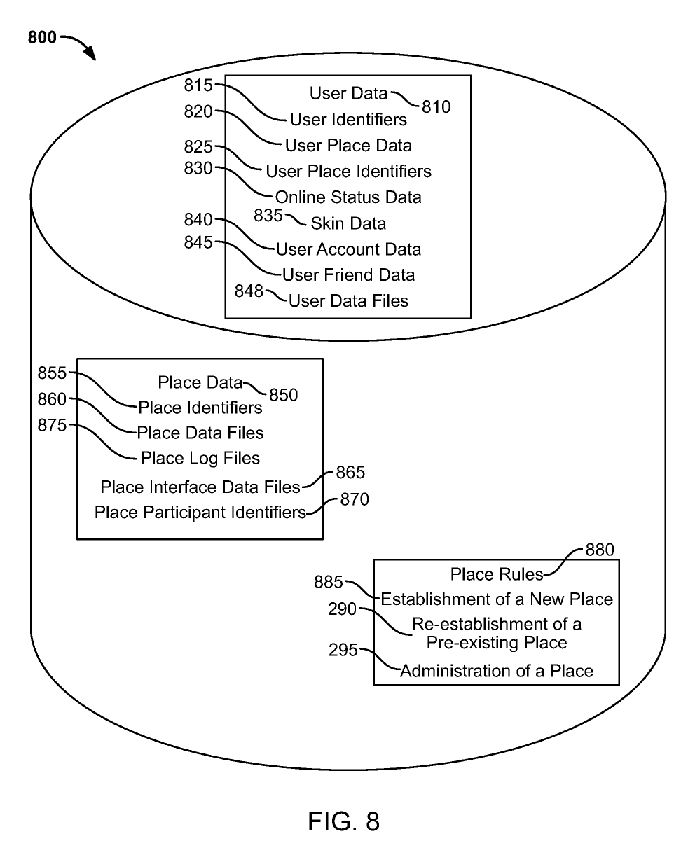

Referring to FIG. 8, schematically illustrates exemplary data for supporting a place. As shown in FIG. 8, the exemplary data 800 includes a user data 810, place data 850, and place rules 880.

User data 810 includes user identifiers 815, user place data 820, user account data 840, user friend data 845, and user data files 848. User identifiers 815 include data identifying the name and login information of each user of the system 700. Usually, the login information includes a user identifier and associated authorization information for accessing the system 700. The user identifier can include a numeric, an alphabetic, or alphanumeric identifiers, such identifiers can include alphabetic, numeric and/or alphanumeric identifiers such as usernames and email addresses. In some embodiments, based on detecting the entrance of user 702 into the system 700, server 740 can alert and/or otherwise notify the user friends that the user 702 has entered the system (e.g. transmit messages to the clients 720 associated with those friends). For example, in one embodiment, server 740 can provide a friend notification display for presentation in the place interface and/or in the active displays of the clients 720 of the user friends. Alternatively and/or in combination, in some embodiments, based on detecting the entrance of user 702 into an active place, server 740 can alert and/or otherwise notify the user friends in the active place that the user has entered the place.

Place data 850 includes data representing the features of places that are supported by the system 700. Place data 850 includes place identifiers 855, place data files 860, place log files 875, place interface data files 865, and place participant identifiers 870. Generally, places can have one of two states, specifically, active or dormant, which states are determined based on whether the places are currently being administered by the server 740 (e.g. based on whether one or more users are currently logged into the places). As further described herein, each place is associated with a place identifier 855, and each place identifier 855 is associated with one or more place data files 860, one or more place log files 875, one or more place interface data files 865, and one or more place participant identifiers 870. The place identifiers 855 include data identifying the names of the places supported by the system 700. The place identifiers 855 can include alphabetic, numeric and/or alphanumeric identifiers that can be at least partially chosen and/or otherwise determined by users of the system 700.

Each place interface data file 865 includes data identifying features of the place interface corresponding to a place identifier 855. As previously indicated herein, server 740 can provide data to clients 720 via a place interface, form a network connection along the clients 720, and mediate interactions among the clients 720. A place interface can include a display and one or more sub-displays, and each display and each sub-display can include one or more check boxes, one or more response boxes, one or more radio buttons, one or more pull-down menus, one or more icons, and/or one or more other visual objects that facilitate collaboration. (An exemplary place interface is shown in FIG. 7). Usually, a place interface includes a primary display (e.g. a window) and one or more secondary or sub-displays therein (e.g. secondary or sub-windows), in which each secondary display supports a different collaboration activity or a feature of a place. In some embodiments, the secondary displays are configured for presenting data based on one or more of the place data files 860, the place log files 875, and the place participant identifiers 870 associated with place identifier 855. Each place interface place data file 865 thus includes data representing the type, number, and organization of displays and sub-displays in the place interface corresponding to place identifier 855.

In some embodiments, the originator of place (e.g. client 740 that first establishes a new place) selects and/or otherwise determines the default features of the place interface, such as the type, number, and organization of displays included in the interface and/or the type, number, and organization of applications included in a system tray of the place interface.

Alternatively, and/or in combination, in some embodiments, the look-and-feel of the place interface of the client 720 can be customized by the end user 102. As shown in FIG. 8, user place data 820 includes skin data 835, which includes user selections and/or determinations of customizable features of place interfaces. The customizable features can include sizes of displays and sub-displays; locations and organizations of sub-displays within a display; font colors, sizes and types; background colors and types; and/or other features known to those of ordinary skill in the art. Generally, each client 720 authorized to access a place can customize the place interface by which it interacts with the server 740 and the other clients 720.

Each place data file 860 includes data files that can be displayed, modified and/or otherwise manipulated by one or more clients 720 (e.g. consecutively and/or concurrently) via a place interface corresponding to a place identifier. As further described herein, in most embodiments, place data files 865 are associated with a place identifier based on the uploading of those files into the corresponding place interface by a client 720 (e.g. based on detecting dragging-and-dropping actions by the client 720). As used herein, the term data files can be understood to include files having types and formats of data known to those of ordinary skill in the art. For example, the term data files can include application files, data files, executable files, object files, program files, operating system files, registry files and other types of data files known to those of ordinary skill in the art. In some embodiments, the place data files 860 include one or more of audio data files, video data files (e.g. still or animated video files), documents including text and/or graphics, and multi-media presentations (e.g. presentation, such as a slide show that include a combination of the foregoing types of data files.

Generally, the place data files 860 are accessible (e.g. are able to be accessed, viewed and/or otherwise modified) by all users in a place, regardless of which user uploaded the data files 860 into the place. As such, the place data files 860 are public data files.

In contrast, user data files 848 are accessible by default by only a single user. As such, user data files 848 are private data files. As further described herein, the disclosed systems and methods provide an office utility via the place interface. In most embodiments, the user can associate one or more data files with corresponding office utility based on uploading those data files into the utility. The uploaded data files are associated with the user identifier 815 of the user and are stored in user data files 848. The user data files 848 can be accessed by default only by the uploading user. In some embodiments, the uploading user can designate the user data files as public data files. For example, in some of such embodiments, the uploading user can copy and/or otherwise transfer one or more of the user data files 848 to the place data files 860 associated with a place identifier 855.

Place log files 875 include data that is generated by the disclosed systems and methods based on interactions between clients in a place corresponding to place identifier 855. As further described herein, in some embodiments, clients 720 can share data files and/or exchange chat messages with each other in a place, and server 740 can generate place log files 875 that can include, among other things, data representing the manipulation of the shared data files (such as the types of manipulation of the shared data files (such as the types of manipulation by the clients 720) in the file and/or transcripts of the exchanged chat messages in the place. The place log files 875 can be provided to clients 720 upon subsequent access to the place.

Place participant identifiers 870 include data identifying the authorized participants of places supported by the system 700. The authorized participants of a place are determined based on the schemes described herein. Place participant identifiers 870 also include data identifying the present participants in (e.g. participants logged into, signed into, or otherwise entered into) an active place.

Place rules 880 includes rules for establishing new place rule 885, rules for re-establishing pre-existing place 290, rules for administering the place 895. As described further herein, the rules for establishing new place 285 include rules for determining the features of the place (e.g. participants, data files, etc), the rules for re-establishing a pre-existing place 890 include rules for identifying the place identifier 855 of the place, accessing stored place data 850 to the clients 720 via a place interface; and the rules for administering a place 895 includes rules for authenticating and otherwise authorizing clients to participate in a place and administering synchronous and asynchronous interactions among the clients 720 in the place, such as exchanging of chat messages or sharing the content.

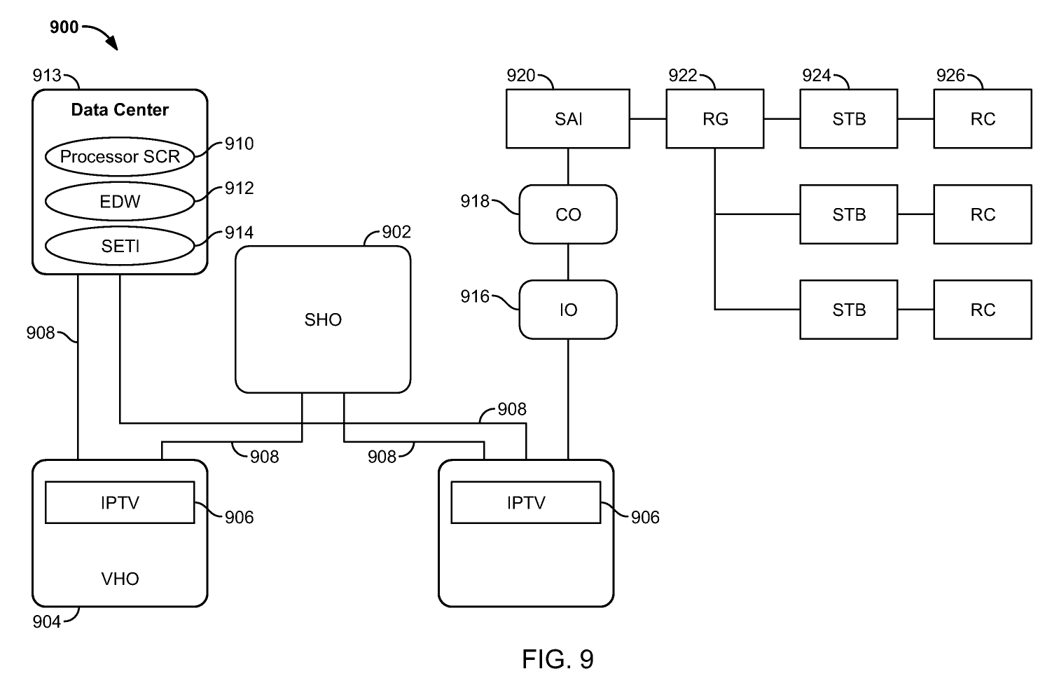

Referring to FIG. 9 is a schematic diagram depicting a communication network employing multiple IPTV instances in accordance with another embodiment of the present invention. As shown in FIG. 9, the communication network 900 is comprised of the following major elements, super hub office (SHO) 902 for acquisition and encoding of video content; video hub office (VHO) 904 in each demographic market area (DMA); an intermediate office (IO) 916 and central office (CO) 918 locations in each metropolitan area; the access network between central office and multiple or single dwelling living units; and the in-home network with residential gateway (RG) 922. The SHO 902 and the VHO 904 communicate view high speed digital communication lines 908.

The video delivery subsystem is broken down into the following two distinct tiers; The SHO 902 distributes content to the VHO 904 which are spread across the various geographic locations. The SHO 902 is in a central location for acquisition and aggregation of international level broadcast television (TV) (or linear) programming. A redundant SHO 902 may be provided for backup in case of failure. The SHO 902 is also a central point of on-demand content insertion into the communication network. Linear programming is received at the SHO 902 via the satellite. On-demand content is received from various sources and processed/encoded to codec and bit-rate requirements for the communication network for transmission to the VHOs 904 over high speed communication link 908. The VHOs 904 receive international content from the SHO 902. The VHOs 904 are the video distribution points within each DMA. All application systems, regional user database systems, VOD servers, and fast channel-change servers (D-servers) are located in the VHO 904. Traffic from VHOs 904 is distributed towards the users first via the intermediate office (IO) 916. The CO's 918 are connected to the IO's 916 and distribute traffic towards the users. Traffic reaches the users residential gateway (RG) 922 at least partially via either fiber to the node (FTTN) or fiber to the premises (FTTP), FTTN equipment, located at a serving area interface (SAI) 920, is connected to the CO 918. Toward the household groups, a network interface device (NID) and RG 922 with a built-in VSDL modem or optical network termination (ONT) comprise the customer premise equipment (CPE). In both cases the RG 922 is connected to the rest of the homes STB's 924 via an internal network such as an Ethernet. Each STB 924 has an associated remote control (RC) 926 which provide data entry to the STB 924 to control the IPTV selections from the IPTV system 906.

User activity data comprising IPTV selection and control inputs and data entry is collected from each household group RG 922 to an IPTV instance at the VHO 904. The data may be collected and transmitted from the RG 922 to the IPTV in real time or on a periodic schedule. A separate IPTV instance runs on a processor in each VHO 904. The IPTV instance platform 906 may be a processor. The user activity data is collected periodically or in real time from each RG 922 and transmitted to the IPTV instance in the VHO 904. A mass storage electronic data warehouse (EDW) 912 is placed in secure data centre 913. A data centre is an internal location within a secured firewall.

EDW 912 comprises a processor and data storage medium that provides mass storage of the user activity data. A subscriber event transmission interface (SETI) application processor 914 associated with the EDW 912 runs in a processor at the data center 913. SETI 914 periodically collects the user activity data from each VHO 904. SETI 914 may also operate in real time to collect the data from the VHO's 904. The user activity data from each VHO 904 is pulled by the SETI 914 periodically or can be collected in real time and relayed to SETI 914. Real time data collection enables real time data analysis for dynamic management of content and advertising at the VHO 904. A processor performs parsing, aggregation and metrics on the user activity data stored on EDW 912. The processor also runs business rules on the metrics. The business rules are stored in the EDW 912.

The set top box 924 may also provide the content, or a portion of the content, to a display device such as a television set, IPTV television set, computer monitor, projection television device, audio-only stereo system or loud speaker, or other display device. The display device may be associated with a telephone number (TN). It will be appreciated that the set top box and the display device may be combined into an integrated device, such as a computer system, or may be distinct devices.

A remote control (RC) 926 and antenna transmits electronically detectable signals to the STB 924. The STB 924 may be coupled to a TV set, a computer, or other display device that is capable of displaying or playing the content, including the audio content. Since the content contains the audio component and/or the additional audio component and/or the additional audio content. The content may be delivered to the display device using traditional video delivery techniques, such as coaxial cables and/or S-video cables, or may be delivered wirelessly, using Wi-Fi, Bluetooth, or other video delivery techniques.

The SHO processor 910 may be implemented as a computer. The STB 924 contains a single microprocessor and memory, or may be implemented as multiple microprocessors and memories located at a single location or at various other locations. A downstream signal from the IPTV network to the display device includes content for display on the display device, and an upstream signal from the display device to the IPTV network instance (via the remote control) includes user activity data comprising channel selections and any other input from the RC 926.

The IPTV data selections are collected from multiple IPTV instances from the VHO's 904 international wide and stored in the EDW 912. The EDW 912 archives user activity data collected internationally so that metrics can be run on the aggregate data and business rules applied to the metrics to examine user activity. User activities may be compared from region to region, between time frames and how separate demographic sectors (ages) react to different programming and advertising.

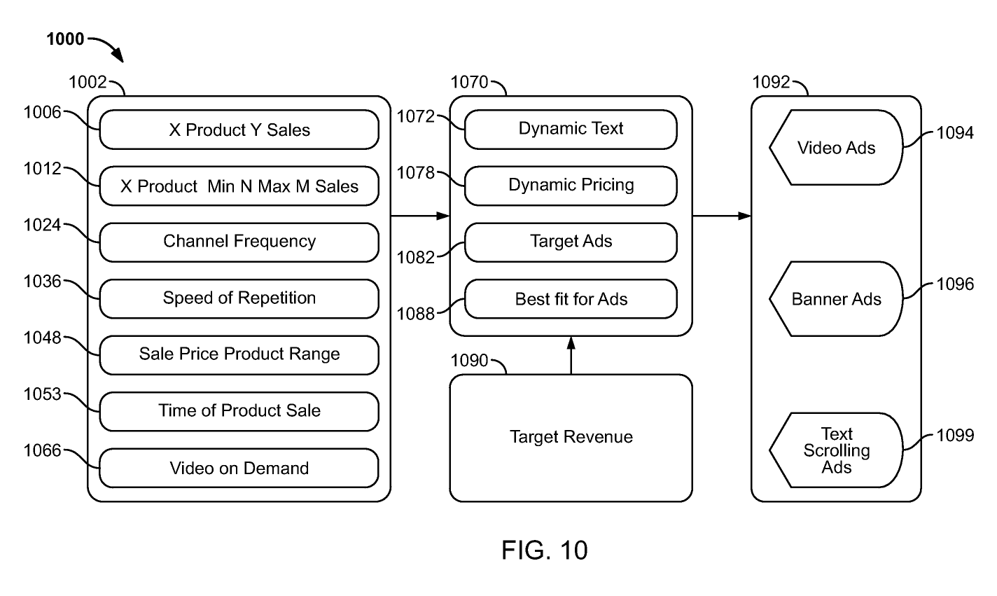

FIG. 10 is a functional block diagram depicting an exemplary system for producing optimal revenue from advertising with another embodiment of the present invention. The illustrative embodiment 1000 comprises an autonomous closed feedback loop system 1002. The system 1002 attempts to produce optimal revenue from advertising and selling products and services and manages complete advertisement campaigns. The system 1002 comprises various parameters for analyzing the advertising to manage the advertisement campaigns. The parameters include X product Y sales parameter 1006 explains that some X product should make Y sales. The X product Min N Max M sales parameter 1012 explains that X product should make a minimum of N sales and also a maximum of M sales. The channel frequency parameter 1024 explains the frequency of the channel. The speed of repetition 1036 explains the repetition speed of the system 1002. The sales price product range parameter 1048 explains the sales prices and the various product ranges that are available to the system 1002. The time of product sale parameter 1053 explains the availability time for selling the product at that particular instance to the system 1002. The video on demand 1066 parameter explains the displaying video as requested by the user.

The system 1002 further comprises a sales target module 1070 that which further comprises a set of targeted modules namely dynamic text module 1072, dynamic pricing 1078, target advertisements module 1082 and the best fit for the advertisements module 1088.

The system 1002 conceptualizes and identifies separate brick module for performing and designing autonomous campaign management. The system 1002 is further able to specify revenue management goals that system will automatically try to achieve. The module 1072 contains a set of dynamic text which may be a combination of numbers, alphabetic, alphanumeric characters, special characters, ascidia characters, images, graphs, charts, games, or the like or the combination thereof. The module 1078 contains various prices which dynamically change as per the market conditions. The module 1082 comprises various advertisements that are targeted to be displayed at a particular time frame as schedule for the identified active users. The module 1088 comprises a set of best fit analysis for identifying the best advertisement to the identified active user based on the historical data or the demographic profiles. The module 1088 using feedback loops on user reactions and user preferences creates a self tuning targeted advertisement in the module 1082. The module 1088 makes user specific advertisements using scripting constructs and key variables. The module 1088 identifies best fit products for various users, user groups, and user sub-groups. The module 1088 identifies the best fit advertisements for the similar product, per dynamic user groups.

The system 1002 further comprises a revenue manager 1090. The manager 1090 produces optimal revenue from advertising. The revenue generated is managed and stored in the module 1090. The revenue generated from the selling products based on the market specifications and further revenue from the services is stored and managed by the manager 1090. The system 1002 further comprises an advertisements module 1092. The module 1092 comprises a video ads module 1094, a banner ads module 1096 and text scrolling ads module 1099. The module 1092 mechanizes and generates systematic approaches wherein, the either the modules 1094, 1096 and 1099 are included or inserted into the targeted advertisements or the combination of these modules 1094, 1096 and 1099. The module 1092 further propagates and switches to targeted advertisement streams on live TV channels during the commercial breaks. The module 1092 further detects digital program insertion or slice point in the upstream of a channel and replaces dynamic targeted advertisements using downstream and returns back to the upstream at each end of the slice point. Additionally, the module 1092 generates dynamic banners and scrolling advertisements using dynamic up selling text. The module 1092 provides advertisements on user specific demands and fulfills the requested demand.

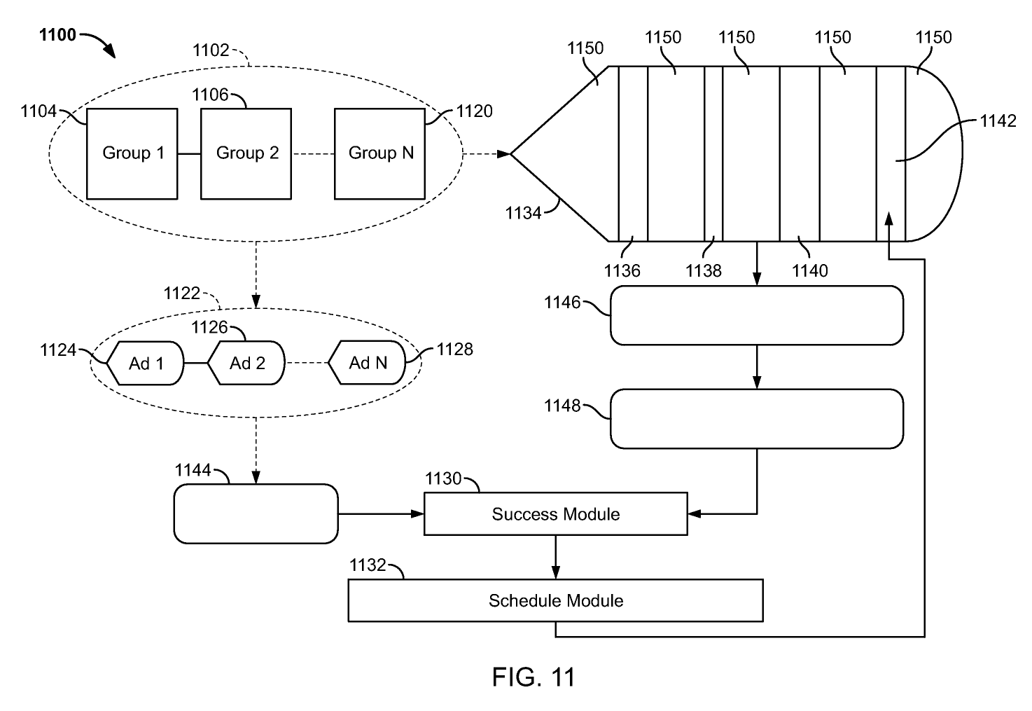

Referring to FIG. 11 is a functional block diagram depicting an exemplary system 1100 for prioritizing to schedule a targeted advertising with another embodiment of the present invention. The system 1100 comprises a group's module 1102, an advertisements module 1122, a candidate advertisement module 1144, a success module 1130, a schedule module 1132, a viewing time module 1134, an advertisement opportunity module 1146 and an advertisement time module 1148.

The module 1102 periodically places user accounts into one or more groups or one or more sub-groups. The module 1122 provides one or more targeted advertisements through one or more techniques of content delivery mechanisms such as live television, video on demand, banner advertisements or the like or the combinations thereof. The module 1144 populates users into their corresponding groups or sub-groups using dynamic group rules editor whereby use criteria such as user demographic profile or behavior data or historical data or user reactions or user specific preferences or the like or the combinations thereof. The module 1130 maps the advertisements to the defined one or more groups or sub-groups based on seed success and current success potentials. The module 1132 prioritizes and schedules the one or more targeted advertisements using the module 1134, 1146 and 1148.

The module 1134 predicts the average viewing time of the one or more active users. The module 1134 further comprises one or more sub streams or downstream 1136, 1138, 1140 and 1142 and one or more mainstreams or upstream 1150. The beginning of each of the sub stream 1136, 1138, 1140, 1142 and ending of each of the mainstream an advertisement break point is detected such as a slice point stream or a DPI. The sub streams consist of one or more types of advertisements to each of the identified one or more groups or sub-groups. Each of the groups and sub-groups comprises one or more set top boxes such as STB1, STB2, or the like or the combination thereof.

The module 1146 comprises one or more advertising opportunities based on the user profiles and historical data. The module 1146 identifies advertising opportunity for a specific time frame or a time period. The algorithms and programs match the user profiles and determine the type of advertisement should be targeted to the active user while watching the data processing device such as live television or the like during a commercial break. The module 1148 determines the total advertising time required for displaying the specific targeted advertisement. For example, if the total advertisement time is fifty minutes, the total, advertisements are fifty and advertisement display opportunity time is eight minutes then the prioritized advertisement list is equal to a number of eight advertisements.

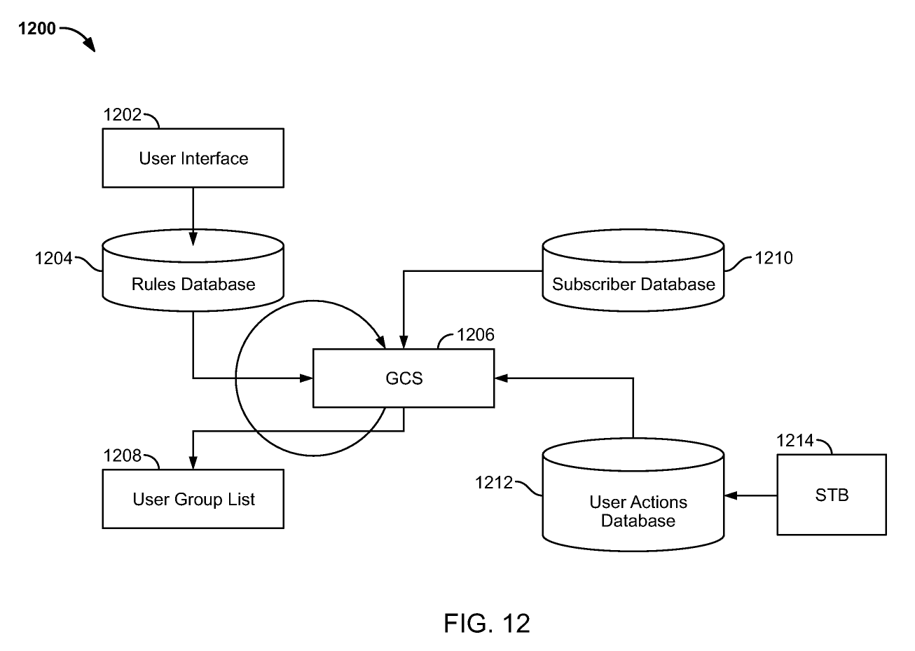

Referring to FIG. 12 is a functional block diagram depicting an exemplary system 1200 for creating groups with another embodiment of the present invention. The system 1200 comprises a user interface module 1202, a rules database 1204, a group creation service (GCS) module 1206, a user group list module 1208, a subscriber database 1210, a user actions database 1212 and a set top box 1214.

As shown in the present invention, the module 1202 records subscriber activity data associated with a subscriber account. The collected subscriber activity data at a particular household is merged for the subscriber account and sent to an IPTV instance at the database 1204. The IPTV instance stores the received subscriber activity data in a temporary database 1204 where the data is staged for transmission to the EDW. Subscriber activity data may include viewing content such as a movie, television program, advertising or other video and/or audio content received from a control centre. Virtually all subscriber activity data associated with the IPTV STB 1214 for a particular RG or household is collected, aggregated, parsed and stored in the EDW for metrics and business rules analysis using the module 1202.

The database 1204 comprises of subscriber's primitives and constructs that support, the rules editor module 1202. The primitives include for example,

<Rules for Group 1>

<Children in household>

Or

<Watch VOD with genre>

Or
. . .
. . .

< /Rules for group 1>

The primitives may be valid for a specified particular amount of time and may be running periodically for a specific time frame.

The constructs may be conditional or un-conditional such as

<Rules for Group 2>

<Age between 22-40>

And

<Number of Adults>

And

<Average viewing TV time is greater than 40 minutes>

And

<Average ‘genre’ news>

And

<Average viewing TV time is greater than 40 minutes>

</Rules for Group 2>

The constructs may be valid for a specified particular amount of time and may be running periodically for a specific time frame.

The database 1210 collects the subscriber's data on per household or account level therein enabling correlation and analysis of viewer demographic and activity based on users account information in the database 1212. The STB 1214 monitors virtually all of the activities associated with an IPTV subscriber account.

The GCS 1206 creates one or more groups or sub-groups. The GCS 1206 runs for a specific amount of time as specified. All the groups and the sub-groups are intersected to identify and determine the common characters or preferences using the demographic data and marked. The marking also includes geographic locations, favorite TV channels, viewing time, or the like or the combination thereof and the targeted advertising is delivered based on the detected identifiers.

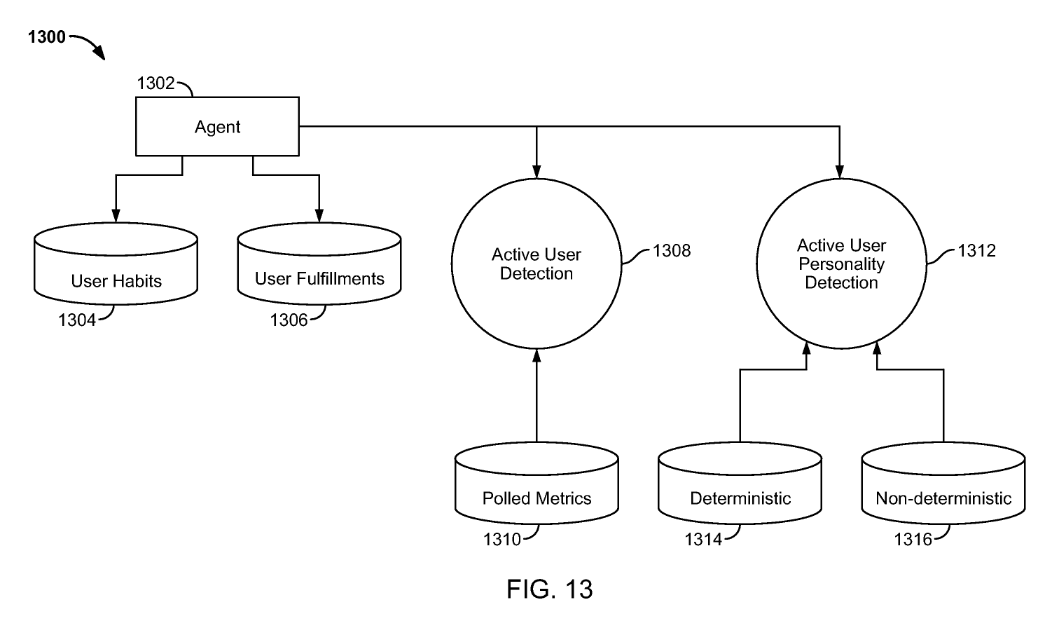

Referring to FIG. 13 is a functional block diagram depicting an exemplary system 1300 for detecting an active user associated with personality detection with another embodiment of the present invention. The system 1300 comprises an agent 1302, an active user detection module 1308 and an active user personality detection module 1312. The agent 1302 is an intelligent system which observes the user actions and catches the raw information and sends to the central database. The agent 1302 includes a user habits module 1304 and a user fulfillments module 1306. The module 1304 consists of complete information about the user. The information includes such as average channel viewing time per weekend, average channel viewing time per weekday, average VOD viewing time per weekend, average VOD viewing time per weekday, average applications viewing time per weekend, average applications viewing time per weekday, channel surfing, window start, most viewed channels, most viewed VOD ratings, subscriber home city, most VOD genres, earliest known awake time per weekday or weekend, or the like or the combinations thereof. The module 1306 includes providing details on the product such as detailed information of the product, purchasing information of the product or the like or the combinations thereof.

The active user detection module 1308 detects whether a user is active or passive using sensing information such as when the user surfs the channel, when changes in commercial, type of programs being watched, based on the channel number that is frequently watched or the like or the combinations thereof. The user interface framework collects information such as user activities, user habits, user actions on work days and week ends channel surfing, top tuner channels or the like. This information is stored in the central database and using the rules editor and the demographic profiles of the active user group allocation is done by the GCS module. During the group creation the seed success percentage is identified. The agent 1302 sends the feedback data and calculates the current success percentage. The polled metrics module consists of information or details such as average viewing time per channel, favorite channels distribution by percentage, favorite genre by percentage of use, volume level per channel, percentage of channel surf possibility, distinctive user habits, surfing percentage during commercials, channel availability and service times, first channel of the day, last channel of the day, follows program start and end times, or the like or the combinations thereof.

The active user personality detection module 1312 detects if the user is actively interacting with the digital data processing device such as TV or the like. The module 1312 also identifies whether the TV program is being displayed to an empty room or to an audience who may not be watching the TV program. The identification process includes unique mathematical modeling and algorithms involving artificial intelligence conceptual logics such as fuzzy logic or swam computing or the like. The identification is processed using the modules 1314 and 1316. The module 1314 consists of information such as pin selection, finger prints on remote, sensing through webcams, tracking user locations and the user, sensing user entrance, sensing user biometric features, or the like or the combinations thereof. The module 1316 includes information such as user personal reaction, actions, selection, interests such as favorite channels, favorite genre, surfing channels, or the like or the combinations thereof. The module 1316 also contains number of personalities and also the number of types of personalities. The module 1312 identifies the viewing personalities from the viewing habits. Additionally, the module 1312 measures viewer habits such as time during which the user watches his favorite show, channel or the like using unique and novel metrics and computational algorithms. The module 1312 detects present viewing personality by comparing current user behavior with predefined default user behaviors for each personality.

The above description is intended to be illustrative, and not restrictive. Many other embodiments will be apparent to those skilled in the art. The scope of the invention should therefore be determined by the appended claims, along with the full scope of equivalents to which such claims are entitled.

As will be appreciated by a person skilled in the art, the various implementations of the present technique provide a variety of advantages. For example, the present technique may be an end to end approach to the modeling and design of network functionality. In addition, in the rapidly changing converged wireless network, this model may be significant for the below stated reasons. The advantages may be summarized as below. Firstly, the cyclic system learns by itself to work more intelligently and accurately keeps working. Secondly, relations among product, groups are created. Thirdly, assets and products with metadata are mapped. Fourthly, simultaneously various advertisements for various audience can be presented.

While, the following description is presented enabling a person of ordinary skill in the art for making and using the invention is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without, the corresponding use of other features. Accordingly, the present invention is not intended to be limited to the embodiment shown but is to be accorded the widest cope consistent with the principles and features described herein.

Many modifications of the present invention will be apparent to those skilled in the arts to which the present invention applies. Further, it may be desirable to use some of the features of the present invention without the corresponding use of other features.

Accordingly, the foregoing description of the present invention should be considered as merely illustrative of the principles of the present invention and not in limitation thereof.

What is claimed is:

1. A method for detecting at least one active user utilizing a set of communication devices over a communication network, the active user detection method comprising:
receiving behavior data, fulfillment data and feedback data for the at least one active user of the set of communication devices accessing content over the communication network using an intelligent agent module;
creating a database of a set of demographic profiles based on the received data using a dynamic group and rules editor module;
grouping a set of the at least one active user of the set of communication devices into their corresponding dynamic group using group creation service module;
receiving a request from the set of the at least one active user to present a targeted advertisement to the at least one active user of the set of communication devices using a business parameters module;
identifying one of the set of demographic profile in the created database that satisfies criteria set forth in the business parameters module; and
transmitting the targeted advertisement to the set of communication devices associated with the demographic profile satisfying the criteria set forth in the business parameters module.

2. The method of claim 1, wherein delivering the targeted advertisement for the at least one active user of the set of communication devices over the communication network that is using either context specific or time specific or demographic profile specific or the like or a combination thereof.

3. The method of claim 2, wherein delivering the targeted advertisement via a set of content delivery mechanisms including live television or video on demand advertisements or the like or the combination thereof.

4. The method of claim 3, wherein the delivering the targeted advertisement via the content delivery mechanism comprises launching the targeted advertisement through either banner advertisements or video advertisements or scrolling advertisements or the like or the combination thereof.

5. The method of claim 1, further comprising categorizing the at least one active user into the dynamic group based on a plurality of user actions and the set of demographic profiles.

6. The method of claim 1, wherein the set of demographic profile includes user-selected preferences with respect to programming content sources.

7. The method of claim 1, wherein the behavior data includes a prior collection of activities conducted via the set of communication devices, comprising at least one of:
program content viewed;
a time frame that the program content was viewed;
an amount of time the at least one active user spent viewing the program content; and
purchasing activities conducted via the set of communication devices.

8. The method of claim 7, wherein the time frame for presenting the advertisement is determined by prioritizing and scheduling the advertisement for the at least one active user based on an average viewing time and advertisement opportunity using current success potentials of one of the targeted advertisement.

9. The method of claim 1, wherein the external data includes at least one of:
income range of the at least one active user of the set of communication devices;
family structure including martial status and number of dependents;
residential location of the at least one active user;
gender of the at least one active user;
age range of the at least one active user; and
credit worthiness of the at least one active user.

10. The method of claim 9, wherein the criteria of the business parameters module include at least one of:
a number of times the targeted advertisement is presented;
a time frame for presenting the targeted advertisement;
a program during which the targeted advertisement is presented;
a target audience to which the targeted advertisement is presented; and
a geographic area in which the targeted advertisement, is presented.

11. The method of claim 1, further comprising determining whether the at least one active user of the set of communication devices to which the targeted advertisement was transmitted have perceived the targeted advertisement by sampling a content data stream distributed to the set of communication devices of the at least one active user during presentation of the targeted advertisement of the at least one active user.

12. The method of claim 1, further comprising mapping the targeted advertisement to the dynamic group defined groups using seed success and the current success potentials.

13. A method for detecting personality of at least one active user of a set of communication device over a communication network, the personality detection method comprising:
identifying current personality of the at least one active user watching the set of the communication devices over the communication network;
detecting present viewing personality by comparing current user behavior data with predefined default user behavior data for the at least one active user of the set of the communication devices over the communication network using an inference engine module; and
detecting the at least one active user of the communication device by polled metric data using an intelligent agent module.

14. The method of claim 13, further comprising tagging an accessed content over the communication network for producing the delivery of the targeted advertisement into a plurality of pieces associated with meta data.

15. The method of claim 13, further comprising detecting digital program insertion or splice point in a main stream of a channel and replacing a dynamic targeted advertisement using a plurality of secondary streams and returning back to the main stream at end of the splice point.

16. The method of claim 13, wherein receiving the targeted advertisement and composing a real advertisement.

17. The method of claim 13, further comprising computing custom offers at custom prices to enable an inference engine module by defining a set of rules for enabling a authoring language and a rules grammar to service operators or content owners or product merchants or combination thereof.

18. The method of claim 13, further comprising generating a dynamic banner and a scrolling advertisement using a dynamic up selling text module.

19. The method of claim 13, further comprising providing product information and fulfillment to one of the specific targeted advertising.

20. The method of claim 13, further comprising providing bookmark on the targeted advertisement for lateral fulfillment without obstructing the current program of the communication device over the communication network.

21. The method of claim 13, further comprising providing the targeted advertisement to the at least one active user based on a behavior data or a fulfillment data or a feedback data or the like or the combination thereof.

22. The method of claim 13, further comprising delivering the targeted advertisement in a machine readable format by authoring and customizing using the inference engine module.

23. The method of claim 13, further comprising authoring at least one language for defining a set of rules to compute custom offers at custom prices using a dynamic group and rules editor module.

24. The method of claim 13, wherein the set of rules of the dynamic group and rules editor module enables a plurality of services to a set of clients including at least one service operator or at least one owner or at least one product merchant or the like thereof.

25. A method for detecting at least one best fit product to deliver a targeted advertisement to a set of communication devices over a communication network, the best fit detection method comprising:
producing optimal revenue from the targeted advertisement using autonomous closed loop feedback module; and
managing an advertisement campaign by selling one of the at least one best fit product using autonomous campaign management module.

26. The method of claim 25, further comprising conceptualizing and identifying for designing the autonomous campaign management module using a brick module.

27. The method of claim 25, further comprising specifying automatically a set of goals for producing optimal revenue from the targeted advertisement.

28. The method of claim 25, further comprising making a set of scrolling advertisements of the targeted advertising using a plurality of scripting constructs and key variables of a scripting module.

29. The method of claim 28, further comprising identifying the best fit product to the at least one active user and at least one user group.

30. The method of claim 29, wherein identification of the best fit product includes identifying a best fit targeted advertisement to the best fit product of the at least one user group.

31. The method of claim 25, further comprising computing a time frame for delivering the best fit targeted advertisement to the at least one user group.

32. The method of claim 25, further comprising propagating for switching to the targeted advertisement on a live television channel during a specific commercial break.

33. The method of claim 25, further comprising a self tuning for creating the targeted advertisement based on a plurality of user preferences and a plurality of user reactions using the autonomous closed loop feedback module.

34. The method of claim 25, further comprising detecting the at least one active user is interacting with one of the set of communication devices.

35. The method of claim 34, wherein the detection of the at least one active user is interacting with one of the set of communication devices comprises:
if the live television channel is being displayed to the at least one active user either paying attention or watching the live television channel; and
if the live television channel is being displayed to an empty room or to at least, one passive user not paying attention or watching the live television channel.

36. A system for detecting at least one active user utilizing a set of communication devices over a communication network, the active user detection system comprising:
an intelligent agent module adapted to receive behavior data, fulfillment data and feedback data for the at least one active user of the set of communication devices accessing content over the communication network;
a dynamic group and rules editor module adapted to create a database of a set of demographic profiles based on the received data;
a group creation service module adapted to group a set of the at least one active user of the set of communication devices into their corresponding dynamic group;
a business parameters module adapted to receive a request from the set of the at least one active user to present a targeted advertisement to the at least one active user of the set of communication devices;
the database adapted to identify one of the set of demographic profile in the created database that satisfies criteria set forth in the business parameters module; and
the set of communication devices adapted to transmit the targeted advertisement to the associated demographic profile satisfying the criteria set forth in the business parameters module.

37. The system of claim 36, wherein delivering the targeted advertisement for the at least one active user of the set of communication devices over the communication network that is using either context specific or time specific or demographic profile specific or the like or a combination thereof.

38. The system of claim 37, wherein delivering the targeted advertisement via a set of content delivery mechanisms including live television or video on demand or video advertisements or the like or the combination thereof.

39. The system of claim 38, wherein the delivering the targeted advertisement via the content delivery mechanism comprises launching the targeted advertisement through either banner advertisements or video advertisements or scrolling advertisements or the like or the combination thereof.

40. The system of claim 36, further comprising categorizing the at least one active user into the dynamic group based on a plurality of user actions and the set of demographic profiles.

41. The system of claim 36, wherein the set of demographic profile includes user-selected preferences with respect to programming content sources.

42. The system of claim 36, wherein the behavior data includes a prior collection of activities conducted via the set of communication devices, comprising at least one of:
program content viewed;
a time frame that the program content was viewed;
an amount of time the at least one active user spent viewing the program content; and
purchasing activities conducted via the set of communication devices.

43. The system of claim 42, wherein the time frame for presenting the advertisement is determined by prioritizing and scheduling the advertisement for the at least one active user based on an average viewing time and advertisement opportunity using current success potentials of one of the targeted advertisement.

44. The system of claim 43, wherein the external data includes at least one of:
income range of the at least one active user of the set of communication devices;
family structure including martial status and number of dependents;
residential location of the at least one active user;
gender of the at least one active user;
age range of the at least one active user; and
credit worthiness of the at least one active user.

45. The system of claim 44, wherein the criteria of the business parameters module include at least one of:
a number of times the targeted advertisement is presented;
a time frame for presenting the targeted advertisement;
a program during which the targeted advertisement is presented;
a target audience to which the targeted advertisement is presented; and
a geographic area in which the targeted advertisement is presented.

46. The system of claim 36, further comprising determining whether the at least one active user of the set of communication devices to which the targeted advertisement was transmitted have perceived the targeted advertisement by sampling a content data stream distributed to the set of communication devices of the at least one active user during presentation of the targeted advertisement of the at least one active user.

47. The system of claim 36, further comprising mapping the targeted advertisement to the dynamic group defined groups using seed success and the current success potentials.

48. The system of claim 36, further comprising detecting personality of the at least one active user of the set of communication device over the communication network comprising:
identifying current personality of the at least one active user watching the set of the communication devices over the communication network;
detecting present viewing personality by comparing current user behavior data with predefined default user behavior data for the at least one active user of the set of the communication devices over the communication network using an inference engine module; and
detecting the at least one active user of the communication device by polled metric data using an intelligent agent module.

49. The system of claim 48, further comprising tagging an accessed content over the communication network for producing the delivery of the targeted advertisement into a plurality of pieces associated with meta data.

50. The system of claim 36, further comprising detecting digital program insertion or splice point in a main stream of a channel and replacing a dynamic targeted advertisement using a plurality of secondary streams and returning back to the main stream at end of the splice point.

51. The system of claim 36, wherein receiving the targeted advertisement and composing a real advertisement.

52. The system of claim 36, further comprising computing custom offers at custom prices to enable an interference engine module by defining a set of rules for enabling a authoring language and a rules grammar to service operators or content owners or product merchants or combination thereof.

53. The system of claim 36, further comprising generating a dynamic banner and a scrolling advertisement using a dynamic up selling text module.

54. The system of claim 36, further comprising providing product information and fulfillment to one of the specific targeted advertising.

55. The system of claim 36, further comprising providing bookmark on the targeted advertisement for lateral fulfillment without obstructing the current program of the communication device over the communication network.

56. The system of claim 36, further comprising providing the targeted advertisement to the at least one active user based on a behavior data or a fulfillment data or a feedback data or the like or the combination thereof.

57. The system of claim 36, further comprising delivering the targeted advertisement in a machine readable format by authoring and customizing using the inference engine module.

58. The system of claim 36, further comprising authoring at least one language for defining a set of rules to compute custom offers at custom prices using a dynamic group and rules editor module.

59. The system of claim 58, wherein the set of rules of the dynamic group and rules editor module enables a plurality of services to a set of clients including at least one service operator or at least one owner or at least one product merchant or the like thereof.

60. The system of claim 36, further comprising detecting at least one best fit product to deliver the targeted advertisement to the set of communication devices over the communication network comprising:
producing optimal revenue from the targeted advertisement using autonomous closed loop feedback module; and
managing an advertisement campaign by selling one of the at least one best fit product using autonomous campaign management module.

61. The system of claim 60, further comprising conceptualizing and identifying for designing the autonomous campaign management module using a brick module.

62. The system of claim 36, further comprising specifying automatically a set of goals for producing optimal revenue from the targeted advertisement.

63. The system of claim 36, further comprising making a set of scrolling advertisements of the targeted advertising using a plurality of scripting constructs and key variables of a scripting module.

64. The system of claim 36, further comprising identifying the best fit product to the at least one active user and at least one user group.

65. The system of claim 64, wherein identification of the best fit product includes identifying a best fit targeted advertisement to the best fit product of the at least one user group.

66. The system of claim 36, further comprising computing the time frame for delivering the best fit targeted advertisement to the at least one user group.

67. The system of claim 36, further comprising propagating for switching to the targeted advertisement on a live television channel during a specific commercial break.

68. The system of claim 36, further comprising a self tuning for creating the targeted advertisement based on a plurality of user preferences and a plurality of user reactions using the autonomous closed loop feedback module.

69. The system of claim 36, further comprising detecting the at least one active user is interacting with one of the set of communication devices.

70. The system of claim 69, wherein the detection of the at least one active user is interacting with one of the set of communication devices comprises:
if the live television channel is being displayed to the at least one active user either paying attention or watching the live television channel; and
if the live television channel is being displayed to an empty room or to at least one passive user not paying attention or watching the live television channel.

71. A tangible computer-readable medium having stored thereon computer executable instructions for detecting at least one active user utilizing a set of communication devices over a communication network, the computer-readable medium comprising:
program code adapted for receiving behavior data, fulfillment data and feedback data for the at least one active user of the set of communication devices accessing content over the communication network using an intelligent agent module;
program code adapted for creating a database of a set of demographic profiles based on the received data using a dynamic group and rules editor module;
program code adapted for grouping a set of the at least one active user of the set of communication devices into their corresponding dynamic group using group creation service module;
program code adapted for receiving a request from the set of the at least one active user to present a targeted advertisement to the at least one active user of the set of communication devices using a business parameters module;
program code adapted for identifying one of the set of demographic profile in the created database that satisfies criteria set forth in the business parameters module; and
program code adapted for transmitting the targeted advertisement to the set of communication devices associated with the demographic profile satisfying the criteria set forth in the business parameters module.

72. The computer-readable medium of claim 71, wherein delivering the targeted advertisement for the at least one active user of the set of communication devices over the communication network that is using either context specific or time specific or demographic profile specific or the like or a combination thereof.

73. The computer-readable medium of claim 71, wherein delivering the targeted advertisement via a set of content delivery mechanisms including live television or video on demand or video advertisements or the like or the combination thereof.

74. The computer-readable medium of claim 73, wherein the delivering the targeted advertisement via the content delivery mechanism comprises launching the targeted advertisement through either banner advertisements or video advertisements or scrolling advertisements or the like or the combination thereof.

75. The computer-readable medium of claim 71, further comprising categorizing the at least one active user into the dynamic group based on a plurality of user actions and the set of demographic profiles.

76. The computer-readable medium of claim 71, wherein the set of demographic profile includes user-selected preferences with respect to programming content sources.

77. The computer-readable medium of claim 71, wherein the behavior data includes a prior collection of activities conducted via the set of communication devices, comprising at least one of:
program content viewed;
a time frame that the program content was viewed;
an amount of time the at least one active user spent viewing the program content; and
purchasing activities conducted via the set of communication devices.

78. The computer-readable medium of claim 77, wherein the time frame for presenting the advertisement is determined by prioritizing and scheduling the advertisement for the at least one active user based on an average viewing time and advertisement opportunity using current success potentials of one of the targeted advertisement.

79. The computer-readable medium of claim 78, wherein the external data includes at least one of:
income range of the at least one active user of the set of communication devices;
family structure including martial status and number of dependents;
residential location of the at least one active user;
gender of the at least one active user;
age range of the at least one active user; and
credit worthiness of the at least one active user.

80. The computer-readable medium of claim 79, wherein the criteria of the business parameters module include at least one of:
a number of times the targeted advertisement is presented;
a time frame for presenting the targeted advertisement;
a program during which the targeted advertisement is presented;
a target audience to which the targeted advertisement is presented; and
a geographic area in which the targeted advertisement is presented.

81. The computer-readable medium of claim 71, further comprising determining whether the at least one active user of the set of communication devices to which the targeted advertisement was transmitted have perceived the targeted advertisement by sampling a content data stream distributed to the set of communication devices of the at least one active user during presentation of the targeted advertisement of the at least one active user.

82. The computer-readable medium of claim 71, further comprising mapping the targeted advertisement to the dynamic group defined groups using seed success and the current success potentials.

83. The computer-readable medium of claim 71, further comprising detecting personality of the at least one active user of the set of communication device over the communication network comprising:
program code adapted for identifying current personality of the at least one active user watching the set of the communication devices over the communication network;
program code adapted for detecting present viewing personality by comparing current user behavior data with predefined default user behavior data for the at least one active user of the set of the communication devices over the communication network using an inference engine module; and
program code adapted for detecting the at least one active user of the communication device by polled metric data using an intelligent agent module.

84. The computer-readable of claim 83, further comprising tagging an accessed content over the communication network for producing the delivery of the targeted advertisement into a plurality of pieces associated with meta data.

85. The computer-readable medium of claim 71, further comprising detecting digital program insertion or splice point in a main stream of a channel and replacing a dynamic targeted advertisement using a plurality of secondary streams and returning back to the main stream at end of the splice point.

86. The computer-readable medium of claim 71, wherein receiving the targeted advertisement and composing a real advertisement.

87. The computer-readable medium of claim 71, further comprising computing custom offers at custom prices to enable an interference engine module by defining a set of rules for enabling a authoring language and a rules grammar to service operators or content owners or product merchants or combination thereof.

88. The computer-readable medium of claim 71, further comprising generating a dynamic banner and a scrolling advertisement using a dynamic up selling text module.

89. The computer-readable medium of claim 71, further comprising providing product information and fulfillment to one of the specific targeted advertising.

90. The computer-readable medium of claim 71, further comprising providing bookmark on the targeted advertisement for lateral fulfillment without obstructing the current program of the communication device over the communication network.

91. The computer-readable medium of claim 71, further comprising providing the targeted advertisement to the at least one active user based on a behavior data or a fulfillment data or a feedback data or the like or the combination thereof.

92. The computer-readable medium of claim 71, further comprising delivering the targeted advertisement in a machine readable format by authoring and customizing using the inference engine module.

93. The computer-readable medium of claim 71, further comprising authoring at least one language for defining a set of rules to compute custom offers at custom prices using a dynamic group and rules editor module.

94. The computer-readable medium of claim 93, wherein the set of rules of the dynamic group and rules editor module enables a plurality of services to a set of clients including at least one service operator or at least one owner or at least one product merchant or the like thereof.

100. The computer-readable medium of claim 71, further comprising detecting at least one best fit product to deliver the targeted advertisement to the set of communication devices over the communication network comprising:
program code adapted for producing optimal revenue from the targeted advertisement using autonomous closed loop feedback module; and
program code adapted for managing an advertisement campaign by selling one of the at least one best fit product using autonomous campaign management module.

101. The computer-readable medium of claim 100, further comprising conceptualizing and identifying for designing the autonomous campaign management module using a brick module.

102. The computer-readable medium of claim 71, further comprising specifying automatically a set of goals for producing optimal revenue from the targeted advertisement.

103. The computer-readable medium of claim 71, further comprising making a set of scrolling advertisements of the targeted advertising using a plurality of scripting constructs and key variables of a scripting module.

104. The computer-readable medium of claim 71, further comprising identifying the best fit product to the at least one active user and at least one user group.

105. The computer-readable medium of claim 105, wherein identification of the best fit product includes identifying a best fit targeted advertisement to the best fit product of the at least one user group.

106. The computer-readable medium of claim 71, further comprising computing the time frame for delivering the best fit targeted advertisement to the at least one user group.

107. The computer-readable medium of claim 71, further comprising propagating for switching to the targeted advertisement on a live television channel during a specific commercial break.

108. The computer-readable medium of claim 71, further comprising a self tuning for creating the targeted advertisement based on a plurality of user preferences and a plurality of user reactions using the autonomous closed loop feedback module.

109. The computer-readable medium of claim 71, further comprising detecting the at least one active user is interacting with one of the set of communication devices.

110. The computer-readable medium of claim 109, wherein the detection of the at least one active user is interacting with one of the set of communication devices comprises:
if the live television channel is being displayed to the at least one active user either paying attention or watching the live television channel; and
if the live television channel is being displayed to an empty room or to at least one passive user not paying attention or watching the live television channel.
